(19) United States
(12) Patent Application Publication
(10) Pub. No.: US 2026/0342154 A1
(43) Pub. Date: Oct. 29, 2026

(54) ROTOR WITH SIMPLIFIED MAGNET HOLDING

(71) Applicant: Moving Magnet Technologies, Besançon (FR)

(72) Inventor: Antoine Foucaut, Montarlot les Rioz (FR)

(21) Appl. No.: 19/124,153

(22) PCT Filed: Nov. 2, 2023
(86) PCT No.: PCT/EP2023/080582

§ 371 Date: Apr. 24, 2025

(30) Foreign Application Priority Data
Nov. 2, 2022 (FR) FR2211412

(51) Int. Cl. H02K 1/278; H02K 1/2791; H02K 1/30; H02K 11/215

(52) U.S. Cl. CPC H02K 1/278; H02K 1/2791; H02K 1/30; H02K 11/215

(57) ABSTRACT

An internal rotor includes a yoke, magnets, a shaft and one or two end plates at the axial end of the rotor. The inner surface of each of the magnets is arranged against the periphery of the yoke. The or each end plate has, on its periphery, N claws projecting in the axial direction, which are formed by blades extending approximately perpendicular to the surface of the end plate. There is interference between the end plates and the assembly composed of the yoke and the magnets. This interference increases as the end plates are axially fitted onto the assembly, such that the claws apply an increasing force on the magnets during assembly. The magnets and claws are inscribed within the tubular casing of the magnets, without penetrating into the air gap between the rotor and the stator.

### CROSS-REFERENCE TO RELATED APPLICATIONS

This application is a national phase entry under 35 U.S.C. § 371 of International Patent Application PCT/EP2023/080582, filed Nov. 2, 2023, designating the United States of America and published as International Patent Publication WO 2024/094801 A1 on May 10, 2024, which claims the benefit under Article 8 of the Patent Cooperation Treaty of French Patent Application Serial No. FR2211412, filed Nov. 2, 2022.

### TECHNICAL FIELD

The present disclosure relates to the field of rotors, constituting the movable part, with respect to the stator, of an electrical machine or an electromagnetic sensor. The rotor takes the form of a cylindrical sleeve driving or being driven by an axle linked to a yoke supporting permanent magnets that induce an electrical voltage in the generator/alternator stator windings separated from the circumferential surface of the rotor by an air gap.

### BACKGROUND

The rotor can rotate at high speeds, resulting in a significant centrifugal force acting on the magnets attached to the periphery of the yoke. These magnets are usually glued to the surface of the yoke or held in place by a peripheral shrink disc. More recently, a solution has also been proposed in which the permanent magnets are integrated into a rotor core, known as an “IPM” (interior permanent magnet), in which the magnets are housed in cavities formed in the yoke, the peripheral extensions of which form the magnetic poles.

In the prior art, International Patent Application Publication No. WO2022243411 describes a rotor for an electric motor, having a rotor body with a cylindrical rotor packet and a number of surface magnets, which are distributed over an outer surface of the rotor packet as rotor poles, and which have a bread loaf-shaped cross-section with a convex curvature oriented toward the outer circumference, and a cuff-shaped protective sleeve arranged on the outer circumference of the rotor body, the protective sleeve having, at least on one end face, a flange collar that is in the radially indented regions between the curvatures of tangentially adjacent surface magnets in a form-and/or force-fitting manner.

Japanese Patent Application JP2003037954 describes a rotor comprising a nonmagnetic magnet holder having a first arm portion and a nonmagnetic rotor cover in the form of a circular tube attached to cover the magnet holder and magnet.

Great Britain Patent Application GB2559059 describes a rotating electric machine, and a rotor manufacturing method wherein the number of components is reduced, fastening is facilitated and misalignment can be suppressed. The rotor comprises: a cylindrical rotor core wherein a plurality of insertion holes are formed; and an annular sensor magnet disposed coaxially with the rotor core. The sensor magnet has a plurality of projection portions projecting in the direction of the rotor core, wherein the projection portions are inserted into the insertion holes.

German Patent Application DE4331803 describes a rotor consisting of a support guided on the rotor shaft and magnet segments arranged on its circumferential surface and, according to the present disclosure, are held in contact with the support via retaining brackets that are likewise guided on the rotor shaft. These retaining brackets are in this case designed such that they provide the centering of the magnet segments during the assembly of the individual components of the rotor and, once all the rotor components have been completely assembled, are then braced via compensation washers in such a manner that they keep the magnet segments pressed radially against the magnet-holder of the rotor.

U.S. Patent Application US20200212739 describes a rotor having magnets located radially outside the rotor core and disposed along a circumferential direction, a holder including a support portion that supports the rotor core and the magnets from a first side in an axial direction, and a rotor cover including a cylindrical portion that surrounds the rotor core, the magnets, and the holder from an outside in a radial direction and that opens toward the first side. The rotor cover comprises a bottom portion that supports the rotor core from a second side of the rotor core in the axial direction. A radially outer edge portion of the support portion comprises a first portion and a second portion adjacent to the first portion in the circumferential direction.

A first disadvantage of prior art solutions is the increased air gap. The magnet fasteners form a ring or protuberances that locally increase the diameter and thus lead to an increase in the air gap.

Compared with other documents, such as International Patent Application WO2022243411 (intervening document), the magnets are poorly held in place by a complementary means such as the addition of a metal peripheral hoop or a plastic overmolding, which also leads to an increase in the magnetic air gap, but also to greater losses when the hoop is made of an electrically conductive material. The rectangular-shaped lugs are not optimized for holding magnets in operation, but only provide temporary support during the assembly process, before final attachment by a complementary means.

In other solutions, the fastening causes magnetic leakage at the slots separating two consecutive magnets, reducing performance.

### BRIEF SUMMARY

In order to overcome the drawbacks of the prior art, the present disclosure relates in its most general sense to a rotor.

The rotor comprises a yoke made of ferromagnetic material and a shaft, the yoke supporting N magnets,
the magnets being held on either side of their axial ends by at least one end plate having at one of its peripheries N claws extending in the axial direction,
the magnets being magnetized radially or by a rotating magnetization generating a radial main field, the width of the magnets being at least three times greater than the distance separating two adjacent magnets at the periphery of the rotor,
the inner surface of each of the magnets being arranged against the periphery of the yoke, and
in one variant, the cross-section of the magnets is curved, the tubular casing has a radius corresponding to the radius passing through the apex of the curved part of the magnets, and the claws come to rest on two consecutive magnets, straddling the slot separating the two consecutive magnets.

Alternatively, the cross-section of the magnets is rectangular, the tubular casing has a radius corresponding to the radius passing through the outer edge of the magnets, and the claws come to bear on a middle area of a magnet.

In addition, in one variant, the claws are resiliently deformable and configured to present, with the profile of the magnets, an increasing interference as a function of the axial fitting of the end plate onto the yoke.

In one variant:
the yoke has trapezoidal cross-section cavities with a large arcuate base,
the end plates have a peripheral ring formed of arcuate segments extending over an angular width of between 0.5 and 2 times the angular width of a magnet, the arcuate segments being connected by deformable segments, each of the arcuate segments having two claws bearing on the outer surface of one or two magnets, fitting inside the tubular casing of the magnetized structure, and
each arcuate segment is bent on the side opposite the claw to form a wedge whose outer face is inclined, in the radial plane, to force centripetal displacement of the arcuate segment by the force exerted on the wedge by the outer edge of the corresponding cavity, during axial fitting of the end plate onto the yoke.

In particular for this variant, the magnets are curved and in that the claws come to rest on the outer surface of two consecutive magnets, inscribing themselves inside the tubular casing of the magnetized structure, the wedges being angularly positioned between two consecutive claws.

Alternatively, the magnets are rectangular in cross-section and in that the claws come to rest at the center of the outer surface of a magnet, inscribing themselves inside the tubular casing of the magnetized structure, the wedges being angularly aligned with the claws.

In all compatible variants, a further feature is that the magnets are of constant cross-section along their entire length.

In all compatible variants, the claws are formed by blades extending perpendicularly to the surface of the end plate and have an end of decreasing width.

In particular, the end plate has a radial rib at the bending edge of each of the claws.

In all compatible variants, the magnets have a curved outer surface.

In one variant, the claws have a three-dimensional wedge shape suitable for fitting into the space between the lateral flanks of two consecutive magnets.

The present disclosure also relates to an electrical machine comprising a stator and a rotor having one or a combination of the features previously described.

In particular, the rotor is located inside the stator.

Alternatively, the rotor is located outside the stator.

The present disclosure also relates to a magnetic sensor comprising a magnetosensitive probe and a rotor having one or a combination of the features previously described.

The inner surface of the magnet is the surface in contact with the rotor yoke, the opposite surface being the outer surface of the magnet. The tubular casing that houses the magnets is a tube whose inner and outer cylindrical surfaces contain the entirety of the magnets, that is, none of the inner or outer surfaces of any of the magnets will pass through either of the cylindrical surfaces of the tubular casing.

### BRIEF DESCRIPTION OF THE DRAWINGS

The present disclosure will be better understood on reading the following description, which concerns a non-limiting exemplary embodiment that is shown by the appended drawings, in which:

FIG. 1 shows an exploded view of a rotor corresponding to a first exemplary embodiment;

FIG. 2 shows a perspective view of the rotor being assembled;

FIG. 3 shows a cross-sectional view of the rotor being assembled;

FIG. 4 shows a perspective view of the rotor after being assembled;

FIG. 5 shows a cross-sectional view of the rotor after being assembled;

FIG. 6 shows a perspective view of the rotor according to a first variant embodiment;

FIG. 7 shows a perspective view of the rotor according to a second variant embodiment;

FIG. 8 shows a detailed axial view of the rotor according to a third variant embodiment;

FIG. 9 shows a perspective view of the rotor according to the third variant embodiment;

FIG. 10 shows a detailed cross-sectional view of a rotor pocket according to the third variant embodiment before the axial insertion of the end plate;

FIG. 11 shows the same detailed view of the third variant embodiment in the state after axial insertion of the end plate;

FIG. 12 shows a detailed axial view of the rotor in a fourth variant embodiment with prismatic magnets;

FIG. 13 shows a perspective view of an angular position sensor comprising a rotor corresponding to the present disclosure; and

FIG. 14 shows a cross-sectional view of a rotor for an external-rotor motor according to a fifth variant embodiment.

### DETAILED DESCRIPTION

The rotor (1) according to the present disclosure comprises a yoke (10) formed by a packet of stacked ferromagnetic laminations, or optionally, for sensor applications, or where magnetic losses are not a major concern, by a non-laminated ferromagnetic material.

This yoke (10) has a generally cylindrical shape, possibly hollowed out by pockets (17) to reduce its weight and inertia. It is linked to a shaft (11) supported by bearings (12, 13). The circumferential surface (14) of the yoke (10) has facets (15) complementary in shape to the rear face (51) of the magnets (50). The rotor has N magnets (50) and the yoke (10) has N complementary facets (15).

Optionally, the yoke (10) features axial ribs (16) forming radial protuberances arranged between consecutive facets (15) to facilitate the positioning of the magnets (50), which are magnetically bonded to the facets (15). The thickness of these axial ribs (16) is less than half the thickness of the magnets (50). Of course, if the magnets are magnetized after they have been positioned on the rotor, the person skilled in the art will have no difficulty in finding a temporary solution to hold them in position before they are finally clamped.

The magnets (50) are surface magnets, formed by elements arranged tangentially on the circumferential surface of the yoke (10), and magnetized radially or with a rotating magnetization with a radial main component. The tangential dimension L of the magnets (50) is at least twice the radial dimension 1 of the magnet (50). Two consecutive magnets (50) are separated by a gap (52) corresponding to the width of the ribs (16). Once assembled, the magnets (50) form a side-by-side circular assembly like the ladyfingers in a charlotte aux fraises, with a succession of magnets (50) whose outer surface defines a tubular casing (55) intersected by narrow gaps. Generally speaking, the means for attaching the magnets (50) to the yoke (10) fully fit inside the tubular casing (55) of the magnets (50), without penetrating into the air gap between the rotor and stator.

The outer surface (54) of the magnets (50) is optionally curved and convex, with a radius of curvature smaller than the radius of the tubular casing (55); it can also be flat.

More particularly, the present disclosure relates to the holding of magnets (50) on the yoke (10) by means of one or more end plates (20, 30) having claws (21, 31) extending in axial directions, substantially perpendicular to the plane of the disc area (22, 32) of the end plates (20, 30).

These end plates (20, 30) are axially fitted onto the yoke (10), on either side of the yoke (10). The claws (21, 31) are bent at an angle less than or equal to 90° to the periphery of the disc area (22, 32) before the end plates (20, 30) are assembled and fitted onto the magnets (50). These end plates interfere with the assembly consisting of the yoke (10) on which the magnets (50) are arranged, the interference increasing as the end plates are axially fitted, so that the claws (21, 31) exert an increasing force on the magnets (50) during this fitting.

### Example of How to Assemble and Hold the Magnets (50) on the Yoke (10)

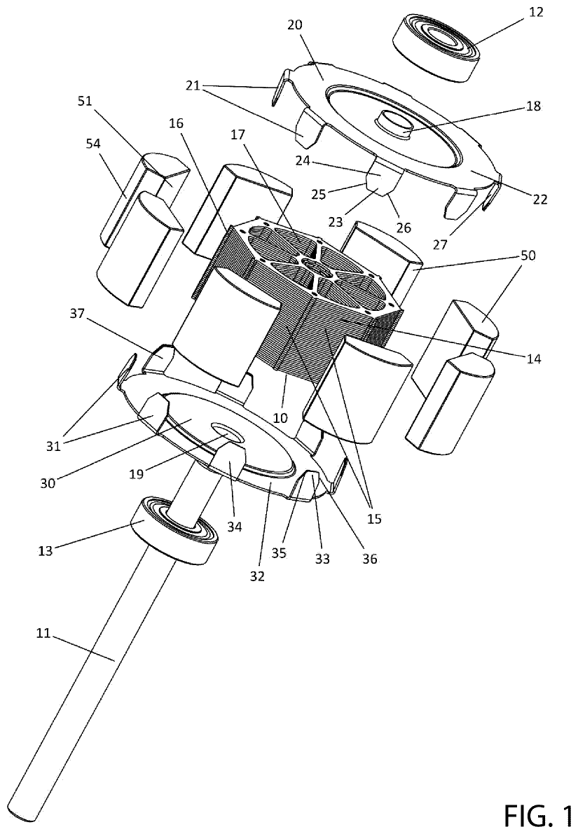

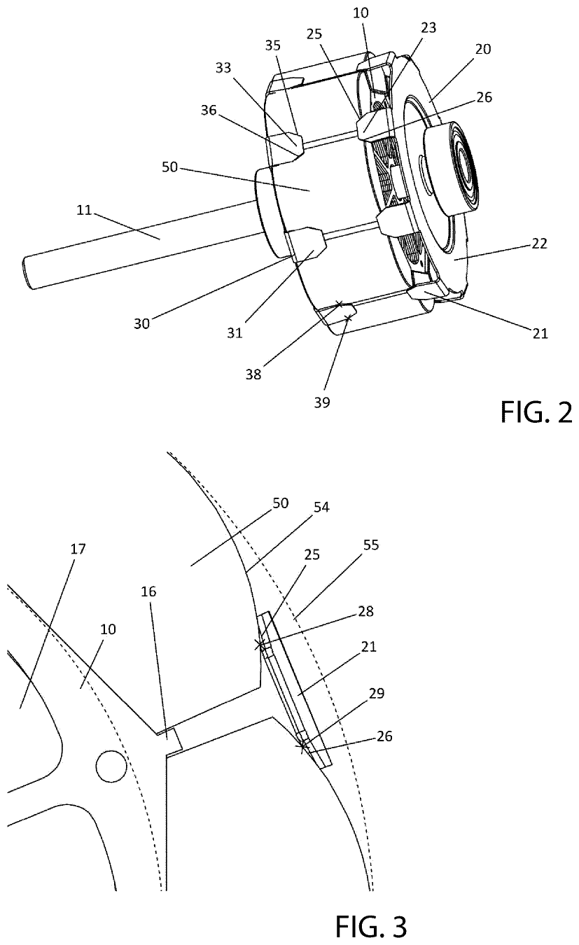

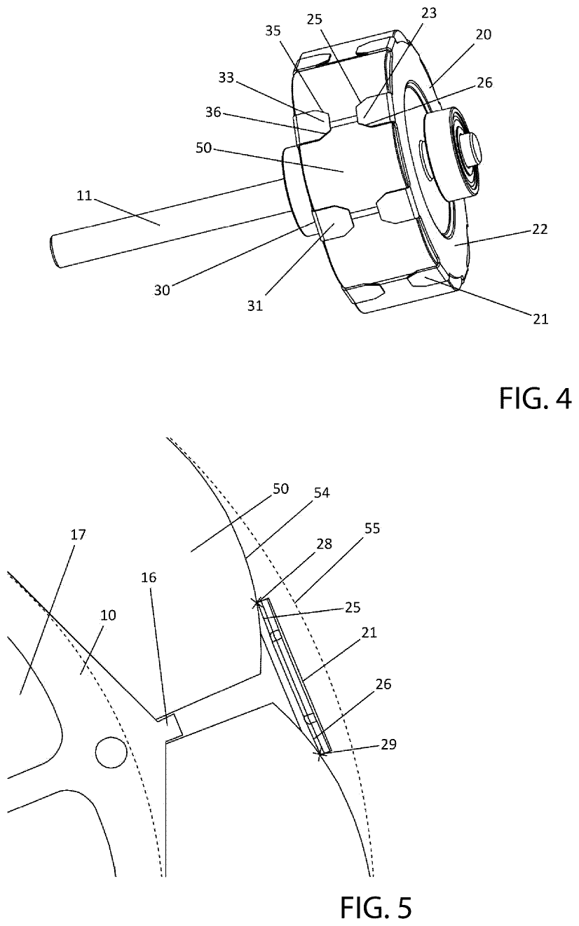

The embodiments shown in FIGS. 1-7 show a preferred embodiment of connecting the magnets (50) to the yoke (10).

This connection is ensured by two end plates (20, 30) featuring claws (21, 31) extending in axial directions, substantially perpendicular to the plane of the disc area (22, 32) of the end plates (20, 30).

These end plates (20, 30) are axially fitted onto the yoke (10), on either side of the yoke (10). The claws (21, 31) are bent at an angle less than 90° to the periphery of the disc area (22, 32), typically between 80° and 88° before the end plates (20, 30) are assembled and fitted onto the magnets (50).

The claws (21, 31) have an end (23, 33) of decreasing width, defining two converging edges (26, 25; 35, 36).

When the claws (21, 31) are fitted onto the outer surface (54) of the magnets, contact is first made in a contact area (28, 29; 38, 39) corresponding to the intersection of the inner face (27, 37) of the claw (21, 31) with the curved outer surfaces (54) of the two adjacent magnets. By exerting pressure on the end plates (20, 30) so as to bring them closer to the axial end of the magnets (50), the claws deform radially, the angle to the periphery of the disc area (22, 32) increasing, and the contact areas (28, 29; 38, 39) move along the two edges (26, 25; 35, 36), the contact areas (28, 29; 38, 39) then optionally being longer than during initial contact when the profile of the ends (23, 33) is designed to be congruent with the landing surface on the outer surfaces (54) of adjacent magnets. There is increasing interference between the claws (21, 31) and the magnets (50) as the end plates (20, 30) are fitted onto the magnets (50) to hold them in place.

When this fitted position of the two end plates is reached, the magnets (50) are firmly held by the radial forces exerted by the elastic bending of the claws (21, 31), and the entire outer surface (24, 34) of the claws (21, 31) fully fits inside in the tubular casing (55) of the magnets (50), without penetrating into the air gap between rotor and stator. The claws thus exert sufficient radial force to withstand the centrifugal forces acting on the magnets when the motor is operated at its maximum speed operating point. The bending angle of the claws does not exceed 90°. In this fitted position, the interference between the claws (21, 31) and the outer surfaces (54) of the magnets is at a maximum.

The disc area (22, 32) of the end plate (20, 30) also features an annular protrusion (18, 19) for guidance on the shaft (11) and as an axial support and stop for the bearings (12, 13).

### Variant for Increasing the Stiffness of the Claws (21, 31)

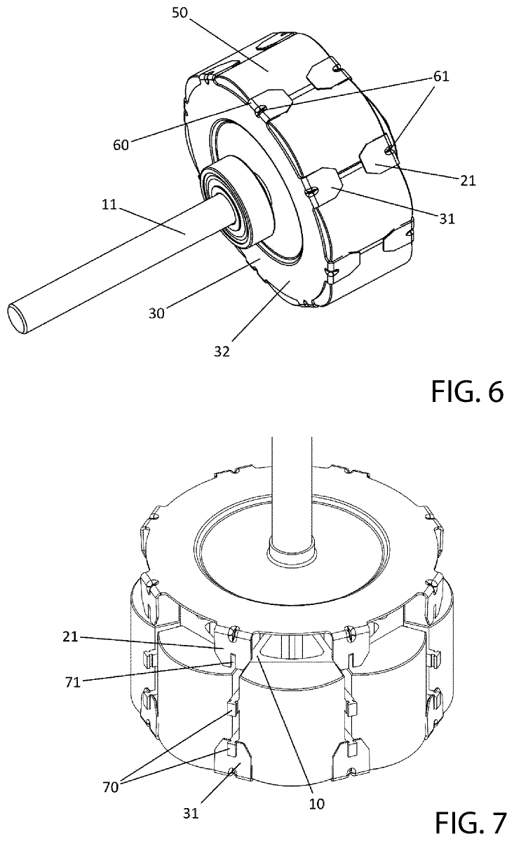

According to a first variant, shown FIG. 6, the bending areas (60) formed between the disc area (22, 32) of the end plate (20, 30) and the claws (21, 31) have a punching or radial rib (61) increasing the stiffness of the claw (21, 31), which makes it possible to use thinner and therefore less expensive sheet metal.

According to a second variant, shown in FIG. 7, the yoke (10) has radial protrusions (70) with a T-shaped cross-section, in the median transverse plane of the yoke (10), and extending over at most one third of the axial height of the yoke (10).

The claws (21, 31) have a complementary notch (71) that engages this radial protrusion (70) to form a radial stop for the end of the claw (21, 31) and prevent it from spreading apart.

### PRODUCING THE END PLATES

The end plates (20, 30) can be made by cutting and stamping a metal sheet, preferably non-magnetic, such as stainless steel or aluminum.

The disc areas (22, 32) of the end plates (20, 30) are preferably solid to seal the pockets (17) and reduce turbulence, which is a source of aeraulic noise.

Additionally, these end plates (20, 30) can be fitted with a counterweight by brazing or machining to balance the rotor.

These two variants are particularly advantageous for high-speed motors.

### Variant Embodiment With Radially Deformable End Plates

In the variants described above, the claws (21, 31) are, at rest, slightly retracted with respect to an end plate (20, 30) whose external diameter corresponds to the diameter of the tubular casing wherein the magnet assembly (50) fits. The axial fitting of the end plate causes centrifugal deformation of the end of the claws (21, 31), through increasing interference with the tubular surface of the magnets (50).

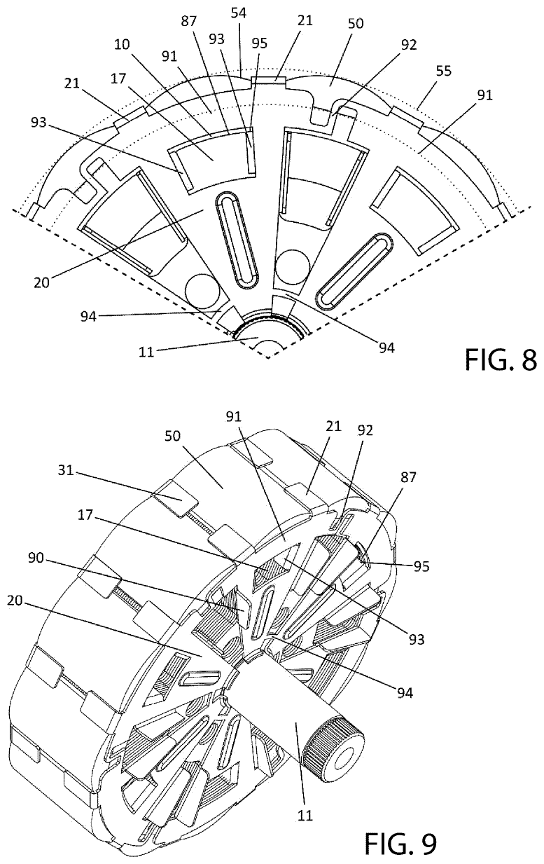

Alternatively, as shown in FIGS. 8-11 or 12, an end plate (20, 30) is provided, which, prior to assembly, has a diameter slightly greater than the diameter of the tubular casing wherein the magnet assembly fits, with deformable areas allowing the diameter to be reduced after assembly to a diameter corresponding to that of the tubular casing of the magnet assembly.

In these variants, where the end plate (20, 30) is of variable diameter, the claws (21, 31) are pressed against the outer surface of the magnets (50) less by elastic deformation (they could even be rigid) but rather by the approach caused by the centripetal deformation of the end plate (20, 30).

This deformation of the end plate (20, 30) can be achieved by cutting alternating arcuate ring segments (91) and deformable segments (92). These deformable segments (92) are formed, for example, by “S”-shaped strip cut-outs to absorb the approach of two consecutive arcuate ring segments (91). These arcuate ring segments (91) and deformable segments (92) define a deformable ring whose diameter can be reduced. The arcuate ring segments (91) are extended to a central area for the shaft (11) to pass through, by points connected to each other by annular connections (94).

The angular width of the arcuate ring segments (91) is between one and two times the angular width of a magnet (50), with the deformable segments (92) occupying the complementary angular width. The deformation may be in the plane of the end plate (20, 30), or in a perpendicular direction.

Each arcuate segment (91) has two claws (21) that rest on the outer surface (54) of one or two magnets, fitting inside the peripheral casing of the magnet structure.

The change in diameter of the end plate (20, 30) results from the interaction with the yoke (10) during its axial fitting.

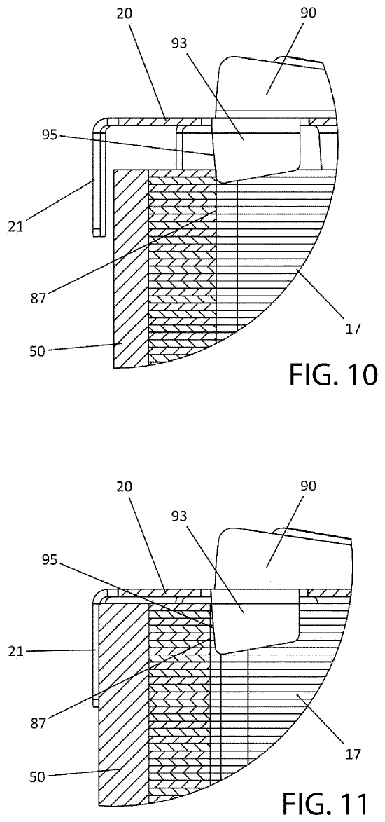

The yoke (10) has cavities (17) of trapezoidal cross-section with a large arcuate base having an angular width less than the angular width of a magnet (50). When the end plate (20, 30) is fitted onto the yoke (10), the outer arcuate surface constrains the centripetal displacement of a wedge (93) formed by bending the arcuate segment (91) on the side opposite the claw (21). This wedge (93), whose outer face (95) is inclined, in the radial plane (that is, the plane containing both the axis of rotation and a radius passing through the center of mass of a wedge), forces the centripetal displacement of the corresponding arcuate segment (91) by the force exerted on the wedge (93) by the outer edge (87) of the corresponding cavity (17), during the axial fitting of the end plate onto the yoke (10), and the crushing of the deformable segments (92) located between two consecutive arcuate segments (91). This deformation mechanically brings the claws (21, 31) closer to the surface of the magnets (50). FIGS. 10 and 11 show a detailed cross-sectional view in a plane parallel to the radial plane, but slightly offset within a cavity (17), so as to be able to observe the insertion of a wedge (93) within the cavity (17). FIG. 10 shows the state at the start of insertion, in which a radial clearance is visible between the outer edge (87) of the cavity (17) and the inclined outer face (95) of the wedge (93). FIG. 11 shows the state at the end of insertion, where this clearance has been taken up, and the outer edge (87) and the inclined outer face (95) are in contact. The clearance between the magnet (50) and the claw (21) has been deliberately exaggerated in FIG. 10 to improve readability, but very slight deformations of the order of 1 or a few tenths of a millimeter ensure that the assembly can take account of manufacturing dispersions, while guaranteeing that the magnet is properly held.

Note that when the end plates (20, 30) are fully fitted onto the yoke (10) of the rotor (1), the stress between the extensions (93) and the outer walls of the cavities (17) is at a maximum. As with previous embodiments, this embodiment comprises increasing interference between the end plates (20, 30) and the yoke (10) of the rotor or the magnets (50), leading to an increase in the holding force of the magnets (50) as the end plates (20, 30) are inserted axially to reach their final assembly position.

In a first embodiment, shown in FIGS. 8-11, the magnets (50) are curved and the claws (21, 31) bear on the outer surface of two consecutive magnets (50), fitting inside the peripheral casing of the magnetized structure, the wedges (93) being angularly positioned between two consecutive claws (21, 31).

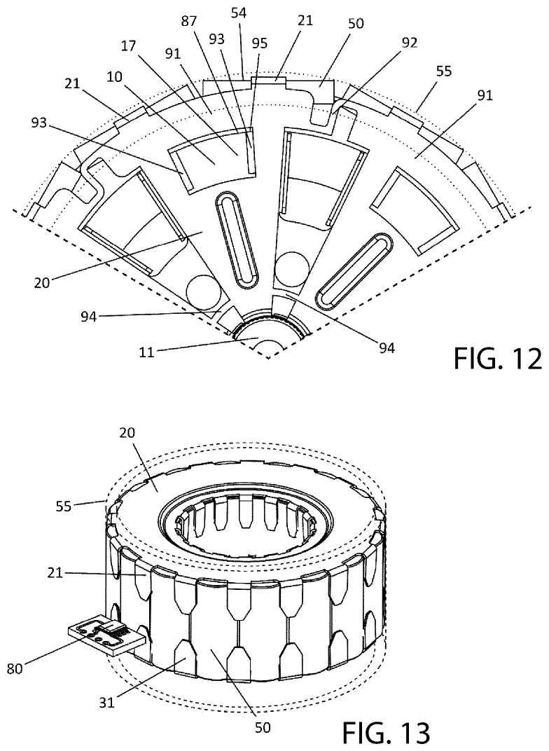

In a second embodiment, shown in FIG. 12, the magnets (50) are rectangular in cross-section and the claws (21, 31) come to rest at the center of the outer surface of a magnet (50), fitting inside the peripheral casing of the magnetized structure, the wedges (93) being angularly aligned with the claws (21, 31).

### COOLING END PLATE

Optionally, as more particularly shown in FIGS. 9 and 10, the end plate (20, 30) can be provided with fins (90) extending to the disc surface for cooling purposes.

### APPLICATION TO PRODUCING A SENSOR

The rotor described above, in its various variants, is applicable to producing a sensor. FIG. 13 shows an exemplary embodiment.

The special feature of the yoke (10) is that the shaft is hollow to allow a driving member to be coupled to the shaft. The magnets (50) are generally more numerous, but thinner than in the application to a motor. A magnetosensitive probe (80) mounted on a printed circuit board (81) is positioned opposite the enveloping surface (55) of the magnets (50). The outer surface of the magnets (50) is configured to produce a sinusoidal variation in the magnetic field as it moves.

Compared to a rotor intended for a motor, a sensor rotor generally rotates at a lower angular speed, but has a larger diameter. As a result, peripheral speed can lead, as in “motor” applications, to relatively high centrifugal forces acting on the magnets (50), which justifies the use of claws as proposed by the present disclosure.

### EXTERNAL-ROTOR VARIANT

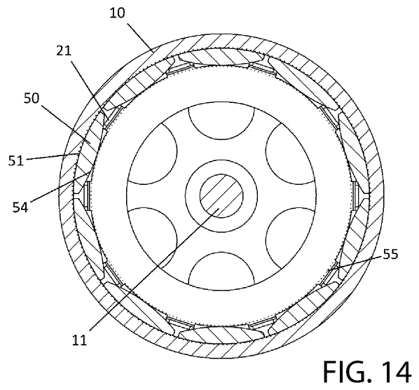

FIG. 14 shows a variant embodiment with an external rotor. This embodiment differs from the previous embodiment in that the rotor is designed to accommodate a stator within it. In this way, the magnets are arranged on the inner periphery of the yoke (10). The magnets are shown in FIG. 14 with shaped poles, but the invention is compatible with parallelepiped magnets as shown in the internal-rotor case.

1. A rotor, comprising: a yoke and a shaft, the yoke supporting N magnets magnetized radially or according to a rotating magnetization generating a radial main field, an inner surface of each of the magnets being arranged against the periphery of the yoke;
the magnets being held on either side of their axial ends by at least one end plate having at one of its peripheries N claws extending in the axial direction, the claws being formed by blades extending obliquely to the surface of the end plate, wherein:
the end plate(s) are configured to be axially fitted onto the assembly comprising the rotor yoke on which the magnets are positioned, with increasing interference with the yoke or the magnets; and
the peripheral casing of the claws fits, after assembly, within the tubular casing inscribing the magnets, the claws coming into constrained contact with part of the outer surface of the magnet.

2. The rotor of claim 1, wherein the cross-section of the magnets is curved, the tubular casing having a radius corresponding to the radius passing through the apex of the curved part of the magnets, and wherein the claws come to rest on two consecutive magnets, straddling the slot separating the two consecutive magnets.

3. The rotor of claim 1, wherein the cross-section of the magnets is rectangular, the tubular casing has a radius corresponding to the radius passing through the outer edge of the magnets, and wherein the claws come to bear on a middle area of a magnet.

4. The rotor of claim 1, wherein the claws are resiliently deformable and configured to present, with the profile of the magnets, an increasing interference as a function of the axial fitting of the end plate onto the yoke.

5. The rotor of claim 1, wherein:
the yoke has trapezoidal cross-section cavities with a large arcuate base;
the end plates have a peripheral ring formed of arcuate segments extending over an angular width of between 0.5 and 2 times the angular width of a magnet, the arcuate segments being connected by deformable segments, each of the arcuate segments having two claws bearing on the outer surface of one or two magnets, fitting inside the tubular casing of the magnetized structure; and
each arcuate segment is bent on the side opposite the claw to form a wedge whose outer face is inclined, in the radial plane, to force centripetal displacement of the arcuate segment by the force exerted on the wedge by the outer edge of the corresponding cavity, during axial fitting of the end plate onto the yoke.

6. The rotor of claim 5, wherein the magnets are curved and the claws come to rest on the outer surface of two consecutive magnets, fitting inside the tubular casing of the magnetized structure, the wedges being angularly positioned between two consecutive claws.

7. The rotor of claim 5, wherein the magnets are rectangular in cross-section and the claws come to rest on the center of the outer surface of a magnet, fitting inside the tubular casing of the magnetized structure, the wedges being angularly positioned between the claws.

8. The rotor of claim 1, wherein the magnets have a constant cross-section over their entire length.

9. The rotor of claim 1, wherein the claws are formed by blades extending in the axial direction at an acute angle to the plane of the disc area of the end plate and have an end of decreasing width.

10. The rotor of claim 9, wherein the end plate has a radial rib at the bending edge of each of the claws.

11. The rotor of claim 1, wherein the magnets have a curved outer surface.

12. The rotor of claim 1, wherein the claws have a three-dimensional wedge shape suitable for fitting into the space between the lateral flanks of two consecutive magnets.

13. The rotor of claim 1, wherein all the means for attaching the magnets to the yoke are located in the tubular casing enclosing the magnets.

14. An electric machine comprising a stator and a rotor according to claim 1.

15. The electric machine of claim 14, wherein the rotor is located inside the stator.

16. The electric machine of claim 14, wherein the rotor is located outside the stator.

17. An electromagnetic sensor comprising a magnetosensitive probe and a rotor according to claim 1.
